(19) United States
(12) Patent Application Publication
(10) Pub. No.: US 2011/0115853 A1
(43) Pub. Date: May 19, 2011

(54) BUBBLE PURGING SYSTEM FOR A FLUID EJECTION HEAD

(76) Inventor: Gregory Alan Long, Georgetown, KY (US)

(21) Appl. No.: 12/618,042

(22) Filed: Nov. 13, 2009

(51) Int. Cl. B41J 2/05; B41J 2/19

(52) U.S. Cl. 347/56; 347/92

(57) ABSTRACT

A method and system for purging bubbles from a fluid ejection head comprising a plurality of fluid flow channels including a first plurality of fluid flow channels flowing a first ink to a first actuator device and a second plurality of fluid flow channels for flowing a second ink to a second actuator device. During a bubble purging operation the first and second actuator devices are pulsed with different energies that depend on the viscosity of the first ink and the second ink. Heating the inks with different energies, results in the viscosity of the first ink to be same as the viscosity of the second ink. In one embodiment, a test pattern that includes a plurality of dots is printed to determine a clogged fluid ejection nozzle. Based on the determination, an actuator device corresponding to the clogged fluid ejection nozzle is pulsed.

### BACKGROUND

1. Field of the Invention

The present invention relates generally to a system and method for purging bubbles from a fluid ejection head and, more particularly to controlling the amount of ink ejected from the ejection head during a purging operation.

2. Description of the Related Art

Ink jet printers have a permanent fluid ejection head, which are not typically replaced by the customers. Rather, the supply item in this case that is replaced is the fluid cartridge mounted on the fluid ejection head. Air management in the fluid cartridge is an issue, since air can enter the fluid cartridge from several different sources resulting in blockage in the fluid ejection head that result in poor print quality if that air is not removed.

To purge bubbles, an air tight seal is provided around a plurality of fluid ejection nozzles of the fluid ejection head. The air tight seal has an opening at one end through which a negative pressure is exerted on the plurality of fluid ejection nozzles. The negative pressure removes ink and unwanted bubbles from the fluid ejection head. The fluidic resistance of the fluid ejection head determines the amount of ink removed during the purging operation. Some of the features that affect the fluidic resistance of ink are flow path length, area of the fluid ejection head, nozzle diameter, and fluid viscosity. Usually, there are significant differences in the flow features and fluid viscosity of monochrome ink compared to color ink.

Due to these differences, when the same pressure is applied to the monochrome ink and color ink during a purging operation, one of the color or monochrome ink is removed more than is needed.

Therefore, it would be advantageous to have a system that can control the amount of ink removed from the fluid ejection head during a purging operation.

### SUMMARY OF THE INVENTION

Disclosed herein is a fluid ejection head including a plurality of fluid flow channels that includes a first plurality of fluid flow channels for flow of a first ink and a second plurality of fluid flow channels for flow of a second ink, the first ink being different from the second ink, a plurality of actuator devices including at least a first actuator device in thermal communication with the first plurality of fluid flow channels for heating the first ink, and at least a second actuator device in thermal communication with the second plurality of fluid flow channels for heating the second ink, a plurality of ink vias formed within the plurality of actuator devices, the plurality of ink vias in fluid communication with the first and second plurality of fluid flow channels, a nozzle plate attached to the plurality of actuator devices, the nozzle plate containing a plurality of fluid ejection nozzles corresponding to the plurality of ink vias, and a printer cap positioned adjacent the nozzle plate, the at least the first actuator device being pulsed with a first energy that depends on a viscosity of the first ink, the at least the second actuator device being pulsed with a second energy that depends on a viscosity of the second ink, the first energy being different from the second energy, a negative pressure being applied through the printer cap for purging bubbles from the first plurality of fluid flow channels, the second plurality of fluid flow channels, the plurality of ink vias, and the plurality of fluid ejection nozzles.

In some embodiments, pulsing the at least the first actuator device with the first energy and pulsing the at least the second actuator device with the second energy results in the viscosity of the first ink to be same as the viscosity of second ink.

In another aspect, a method for purging bubbles from a plurality of fluid flow channels and a plurality of ink vias of a fluid ejection head, the method includes pulsing the at least the first actuator device with a first energy, pulsing the at least the second actuator device with a second energy, and applying a negative pressure through the printer cap to purge bubbles from the first plurality of fluid flow channels, the second plurality of fluid flow channels, the plurality of ink vias, and the plurality of fluid ejection nozzles, the first energy being different from the second energy, the first energy and the second energy depending on the viscosity of the first ink and the second ink.

In yet another aspect, a method for purging bubble clogged in fluid ejection nozzles of a fluid ejection head, the method includes printing a pattern comprising a plurality of dots, each of the plurality of dots represents fluid ejection from the plurality of fluid ejection nozzles, scanning the pattern to determine missing one of the plurality of dots in the pattern, the missing one of the plurality of dots being indicative of a clog in one of the plurality of the fluid ejection nozzles, pulsing the actuator device associated with the clogged fluid ejection nozzle, and applying a negative pressure through the printer cap to purge the bubble from the clogged fluid ejection nozzle.

Additional features and advantages of the invention will be set forth in the detailed description which follows, and in part will be readily apparent to those skilled in the art from that description or recognized by practicing the invention as described herein, including the detailed description, which follows, the claims, as well as the appended drawings.

It is to be understood that both the foregoing general description and the following detailed description of the present embodiments of the invention are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and together with the description serve to explain the principles and operation of the invention.

### BRIEF DESCRIPTION OF THE DRAWINGS

The above-mentioned and other features and advantages of the various embodiments of the invention, and the manner of attaining them, will become more apparent will be better understood by reference to the accompanying drawings, wherein:

FIG. 1 is a perspective view of one embodiment of a fluid ejection head body including a fluid ejection head according to the present invention;

FIG. 2 is a perspective view of a fluid cartridge mounted on the fluid ejection head body of FIG. 1;

FIG. 3 illustrates a sectional view of the fluid ejection head of FIG. 1;

FIG. 4 illustrates a sectional view of one embodiment of the fluid ejection head and a printer cap according to the present invention;

FIGS. 5a-5b illustrate a plan view of one embodiment of a partial portion of the fluid ejection head showing fluid flow channels, fluid ejection nozzles, and actuator device for monochrome ink and color ink according to the present invention;

FIG. 6 is a graphical representation of a change in viscosity of ink with change in temperature;

FIG. 7 illustrates one embodiment of processing steps for purging bubbles from the fluid ejection head according to the present invention;

FIG. 8 illustrates a sectional view of one embodiment of the fluid ejection head and the printer cap with the actuator devices on separate substrates according to the present invention;

FIG. 9 illustrates one embodiment of processing steps for detecting clogged fluid ejection nozzles and purging bubbles from the clogged fluid ejection nozzles according to the present invention; and

FIG. 10 illustrates another embodiment of processing steps for detecting a clogged fluid ejection nozzle according to the present invention.

### DETAILED DESCRIPTION

Reference will now be made in detail to the exemplary embodiment(s) of the invention, as illustrated in the accompanying drawings. Whenever possible, the same reference numerals will be used throughout the drawings to refer to the same or like parts.

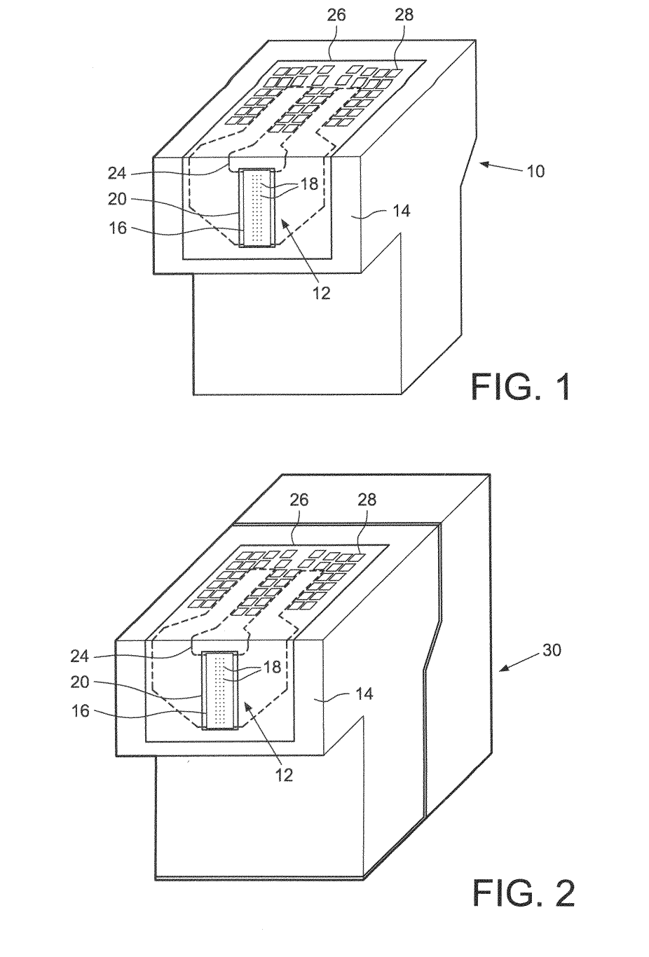

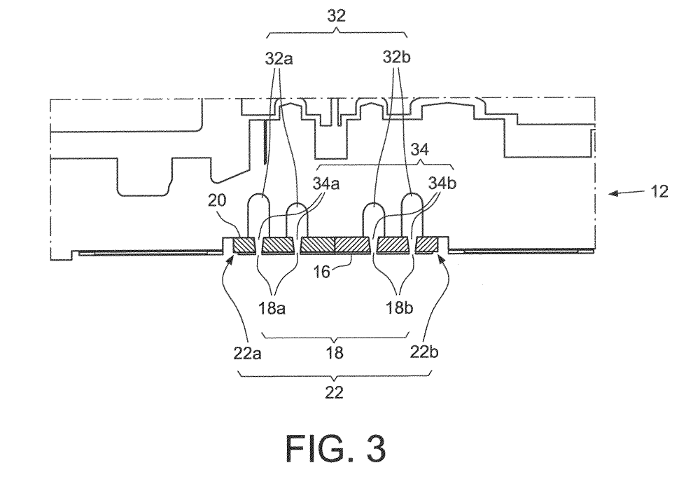

FIG. 1 is a perspective view of a fluid ejection head body 10, including a fluid ejection head 12 disposed on an ejection head area 14 of the fluid ejection head body 10. The fluid ejection head 12 includes a nozzle plate 16, containing a plurality of fluid ejection nozzles 18, attached to a substrate 20 containing actuator devices 22 (FIG. 3). Power is provided to the actuator devices 22 on the substrate 20 by electrical tracing 24 and a flexible circuit 26 containing electrical contact pads 28.

FIG. 2 is a perspective view of a fluid cartridge 30 mounted on the fluid ejection head 12 of FIG. 1. The fluid ejection head 12 ejects fluids, such as ink, contained in the fluid cartridge 30.

FIG. 3 illustrates a sectional view of the fluid ejection head 12 of FIG. 1. The fluid ejection head 12 includes a plurality of fluid flow channels 32 that receive ink from the fluid cartridge 30. The plurality of fluid flow channels 32 may include a first plurality of fluid flow channels 32a that receive a first ink and a second plurality of fluid flow channels 32b that receive a second ink that is different from the first ink. In one embodiment, the first ink is a monochrome ink and the second ink is a color ink. In another embodiment, the first ink and the second ink are both color inks, but may be of different colors.

The fluid ejection head 12 also includes the plurality of actuator devices 22, formed on the substrate 20 attached to the fluid ejection head 12. The plurality of actuator devices 22 include a first actuator device 22a associated with the first plurality of fluid flow channels 32a and a second actuator device 22b associated with the second plurality of fluid flow channels 32b. The actuator devices 22 are preferably heater resistor devices.

A plurality of ink vias 34 are formed within the plurality of actuator devices 22. The plurality of ink vias 34 include a first plurality of ink vias 34a that are in fluid communication with the first plurality of fluid flow channels 32a, and a second plurality of ink vias 34b that are in fluid communication with the second plurality of fluid flow channels 32b.

The fluid ejection head 12 also includes a nozzle plate 16 attached to the substrate 20. The nozzle plate 16 includes the plurality of fluid ejection nozzles 18 formed within the nozzle plate 16. As shown, the fluid ejection nozzles 18a and 18b are associated with the ink vias 34a and 34b, respectively.

Air bubbles may be formed in the ink present in the plurality of fluid flow channels 32, the plurality of ink vias 34, and/or the plurality of fluid ejection nozzles 18. If these air bubbles are not removed, they may block or inhibit the flow of fluid from the fluid flow channels 32 to the ink vias 34, or from the ink vias 34 to the plurality of fluid ejection nozzles 18, causing poor print quality.

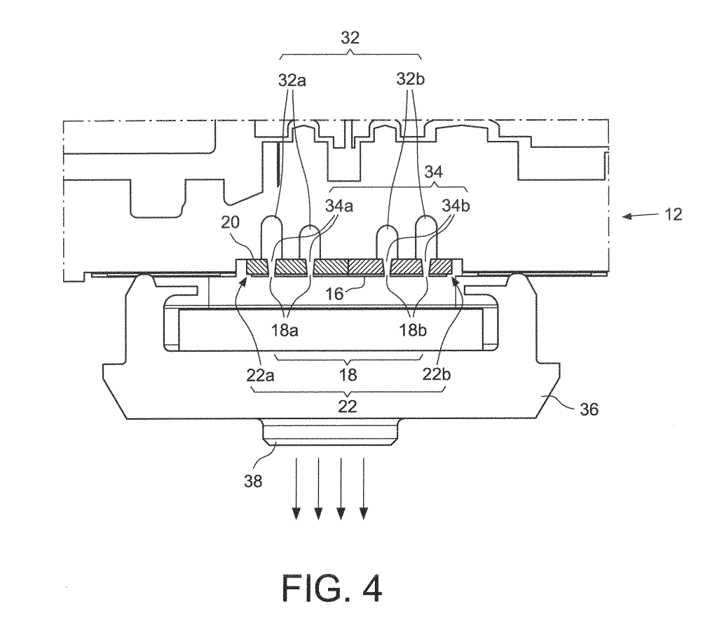

FIG. 4 illustrates a sectional view of the fluid ejection head 12 and a printer cap 36 attached to the fluid ejection head 12 for purging bubbles from the plurality of fluid flow channels 32, the plurality of ink vias 34, and/or the plurality of fluid ejection nozzles 18. The printer cap 36 provides an air tight seal for the fluid ejection head 12. The printer cap 36 has an opening 38 through which a negative pressure is applied. This negative pressure purges bubbles and ink from the plurality of fluid flow channels 32, the plurality of ink vias 34, and the plurality of fluid ejection nozzles 18. The amount of ink removed during a bubble purging operation depends on the area of the fluid flow channel 32, diameter of the fluid ejection nozzles 18, and the viscosity of the inks flowing in the plurality of fluid flow channels 32.

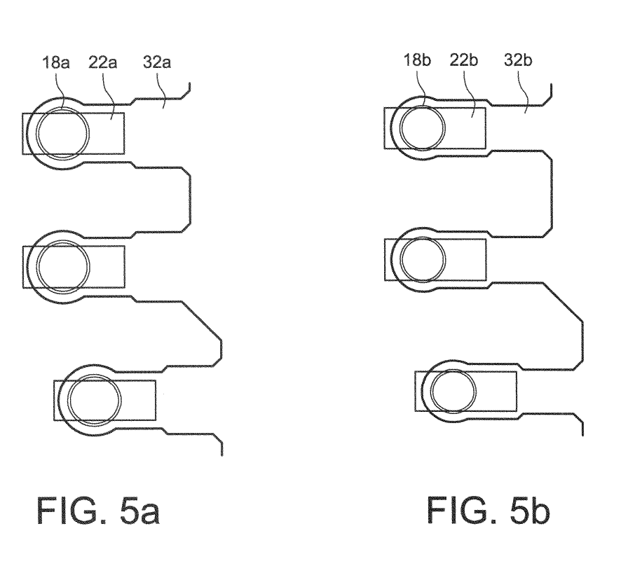

FIGS. 5a-5b illustrate a plan view of one embodiment of a partial portion of the fluid ejection head 12 showing the plurality of fluid flow channels 32, the plurality of fluid ejection nozzles 18, and the plurality of actuator devices 22 for monochrome ink and color ink, respectively, according to the present invention. As a larger ink drop size of a monochrome ink is desired compared to the ink drop size of a color ink, the size of flow features, i.e., size of the fluid flow channel 32a, and the diameter of the fluid ejection nozzle 18a for a monochrome ink is comparatively larger than the size of flow features, i.e., size of the fluid flow channel 32b and the diameter of the fluid ejection nozzle 18b for a color ink. Further, the viscosity of color ink is different from the viscosity of monochrome ink.

Due to the difference in the flow features and the viscosity of color ink and monochrome ink, when the same negative pressure is applied for purging bubbles from the color ink and the monochrome ink, one of the inks is removed more than is needed to ensure that the bubbles is removed. The present invention alleviates the problem of removing excess ink by pulsing the actuator device 22a associated with the first plurality of fluid flow channels 32a with a first energy and pulsing the actuator device 22b associated with the second plurality of fluid flow channels 32b with a second energy that is different from the first energy. The first energy and the second energy are based on the viscosity of the first ink and the second ink, respectively, to ensure that the flow rates of different inks can be controlled independently, and more or less ink of a selected color can be removed during the purge operation while applying the same pressure over the same time span for all the inks.

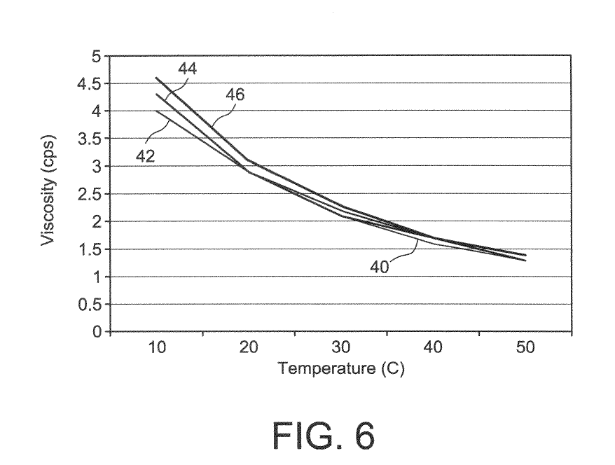

FIG. 6 is a graphical representation of a change in viscosity of ink with a change in temperature. The graph shows this change in the viscosity of ink with the change in temperature for four inks: cyan ink 40, black ink 42, yellow ink 46, and magenta ink 48. This information is stored in firmware (not shown) of an image forming device (not shown) that includes the fluid ejection head 12.

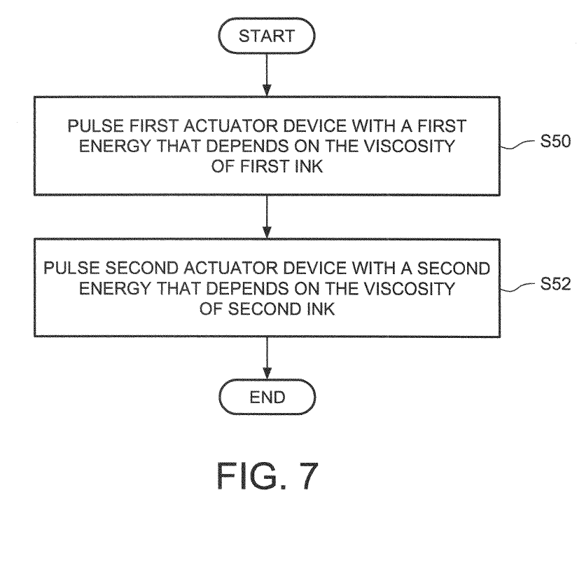

FIG. 7 illustrates one embodiment of the processing steps for purging bubbles from the fluid ejection head 12 according to the present invention. At step S50 the first actuator device 22a that is in thermal communication with the first plurality of fluid flow channels 32a is pulsed with a first energy. The first energy heats the first ink flowing in the first plurality of fluid flow channels 32a. The first energy with which the first actuator device 22a is pulsed is determined based on the relationship between change in viscosity of the first ink with the change in temperature stored in the firmware. The first energy changes the viscosity of the first ink such that only a desired amount of first ink is purged out during the purging of bubbles present in the first plurality of fluid flow channels 32a, plurality of ink vias 34a in fluid communication with the first plurality of fluid flow channels 32a, and the fluid ejection nozzles 18a in communication with the ink vias 34a.

At step S52 the second actuator device 22b that is in thermal communication with the second plurality of fluid flow channels 32b is pulsed with a second energy. The second energy heats the second ink flowing through the second plurality of fluid flow channels 32b. The second energy with which the second actuator device 22b is pulsed is determined based on the relationship between change in viscosity of the second ink with the change in temperature stored in the firmware. The second energy changes the viscosity of the second ink such that only a desired amount of second ink is purged out during the purging of bubbles present in the second plurality of fluid flow channels 32b, the plurality of ink vias 34b in fluid communication with the second plurality of fluid flow channels 32b, and the fluid ejection nozzles 18b in communication with the ink vias 34b.

Heating the first ink and the second ink with the first energy and the second energy that depend on the viscosity of the first ink and the second ink, results in the viscosity of the first ink to be same as the viscosity of the second ink. This ensures that an excess amount of either the first ink or the second ink is not purged out when same the negative pressure is applied through the printer cap 36 for purging bubbles present in the plurality of fluid flow channels 32, the plurality of ink vias 34 in fluid communication with the plurality of fluid flow channels 32, and the fluid ejection nozzles 18 in communication with the ink vias 34. Although, the method discussed here is only for two inks, purging bubbles from any number of inks having different viscosities by heating the inks based on their viscosity would fall within the scope of the invention.

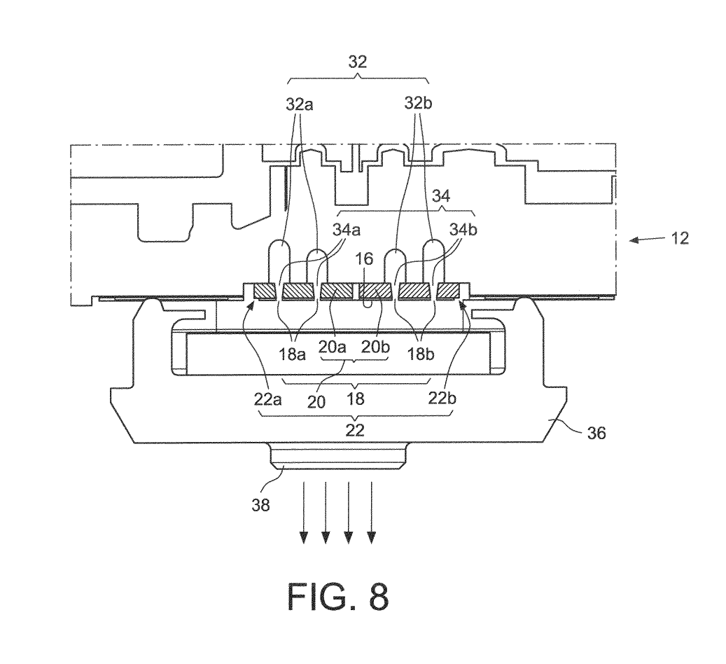

FIG. 8 illustrates a sectional view of one embodiment of the fluid ejection head 12 and the printer cap 36 according to the present invention. As shown, the first actuator device 22a is provided on a first substrate 20a and the second actuator device 22b is provided on a second substrate 20b separated from the first substrate 20a. Providing the first actuator device 22a and the second actuator device 22b on different substrates thermally isolates the actuator device 32a from each other, resulting in better and more accurate heating of the inks and thus better control on the amount of ink purged during a bubble purging operation.

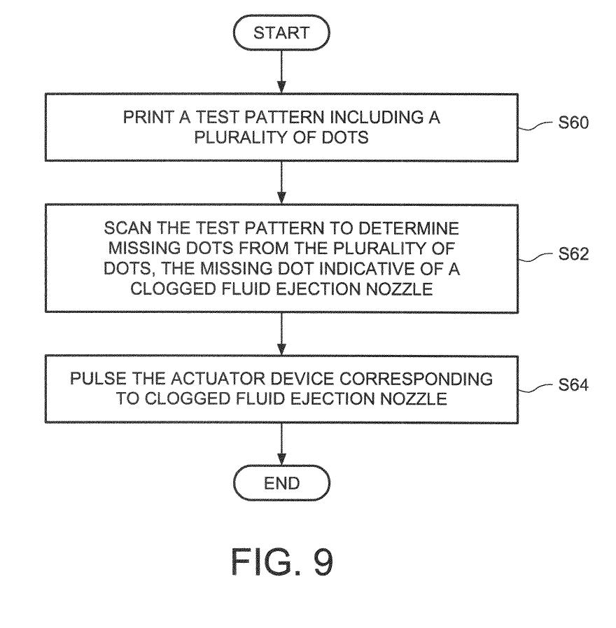

FIG. 9 illustrates one embodiment of processing steps for detecting clogs, if any, in the fluid ejection nozzles 18 and purging bubbles from the clogged fluid ejection nozzles 18 according to the present invention. Initially at step S60, a test pattern is printed by the fluid ejection head 12. The test pattern includes a plurality of dots of different colors (two colors in case of two inks). Each dot is representational of one of the plurality of fluid ejection nozzles 18. At step S62, the test pattern is scanned and a determination is made that if there are any missing dots from the plurality of dots in the test pattern. The missing dots are representational of a clog in the corresponding fluid ejection nozzle (18a, 18b). For example, in case the missing dots are of a color of the first ink that flows in the first plurality of fluid flow channels 32a, the fluid ejection nozzles 18a that are in fluid communication with the first plurality of fluid flow channels 32a are the clogged fluid ejection nozzles. At step S64, the actuator device 22a that corresponds to the clogged fluid ejection nozzles 18a is pulsed. Finally, a negative pressure is applied through the printer cap 36 to purge the bubble clogged in the fluid ejection nozzle 18a.

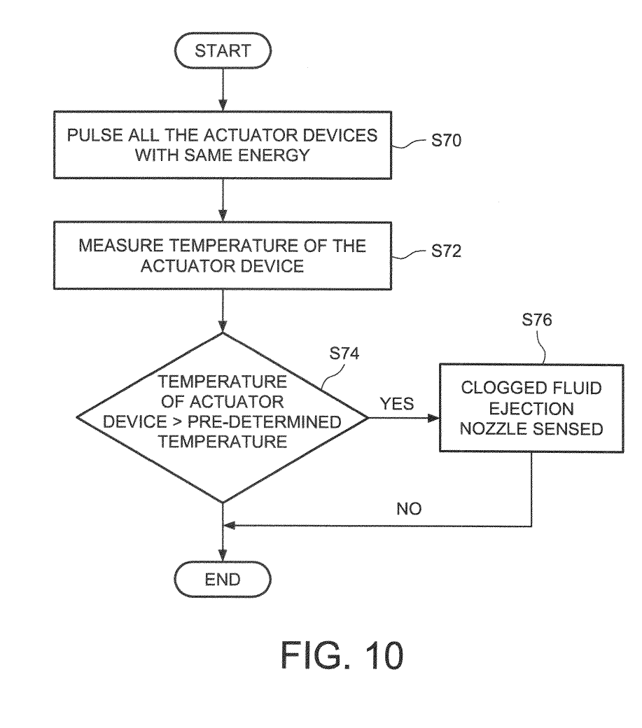

FIG. 10 illustrates another embodiment of processing steps for detecting a clog in the plurality of fluid ejection nozzles 18 of the fluid ejection head 12 according to the present invention. At step S70, the plurality of actuator devices 22 are pulsed with a constant energy to heat the ink flowing through the plurality of fluid flow channels 32. At step S72, the temperature of the plurality of actuator devices 22 is measured. If the temperature of the plurality of actuator devices 22 is greater than a predetermined steady state temperature (step S74), the plurality of fluid ejection nozzles 18 is determined as clogged (step S76). In case the plurality of fluid ejection nozzles 18 are not clogged, the heat from the plurality of actuator devices 32 is removed by the ink flowing out through the plurality of fluid ejection nozzles 18 when negative pressure is applied through the printer cap 36, resulting in the temperature of the plurality of actuator devices 32 to be at the steady state temperature. However, in case of a clog in the plurality of fluid ejection nozzles 18, ink cannot flow out from the fluid ejection head 12 and remove the heat when negative pressure is applied through the printer cap 36, resulting in the temperature of the actuator devices 22 to be higher than the steady state temperature. This temperature information is then used to direct the customer to replace or repair the fluid ejection head 12.

The above described method of clog detection can also be utilized to determine a “deprime” situation, i.e., a situation when the plurality of fluid ejection nozzles 18 are filled only with air. This situation can arise, if the fluid cartridge 30 is not properly mounted on the fluid ejection head 12 or if there is a leak in the fluid ejection head 12 causing air to be filled in the fluid ejection nozzles 18. The deprime situation of the fluid ejection head 12 can be detected similar to the clog situation, by pulsing the plurality of actuator devices 22. If the plurality of fluid ejection nozzles 18 are filled with air heat would not be removed from the fluid ejection head 12 when negative pressure is applied through the printer cap 36, resulting in the temperature of the actuator devices 22 to be higher than the steady state temperature. This temperature information is then used to direct the customer to replace or repair the fluid ejection head 12.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A fluid ejection head comprising:
a plurality of fluid flow channels including a first plurality of fluid flow channels for flow of a first fluid and a second plurality of fluid flow channels for flow of a second fluid, the first fluid being different from the second fluid;
a plurality of actuator devices including at least a first actuator device in thermal communication with the first plurality of fluid flow channels for heating the first fluid, and at least a second actuator device in thermal communication with the second plurality of fluid flow channels for heating the second fluid;
a plurality of fluid vias formed within the plurality of actuator devices, the plurality of fluid vias in fluid communication with the first and second plurality of fluid flow channels;
a nozzle plate attached to the plurality of actuator devices, the nozzle plate containing a plurality of fluid ejection nozzles corresponding to the plurality of fluid vias; and
a cap positioned adjacent the nozzle plate, the at least the first actuator device being pulsed with a first energy that depends on a viscosity of the first fluid, the at least the second actuator device being pulsed with a second energy that depends on a viscosity of the second fluid, the first energy being different from the second energy, a negative pressure being applied through the cap for purging bubbles from the first plurality of fluid flow channels, the second plurality of fluid flow channels, the plurality of fluid vias, and the plurality of fluid ejection nozzles.

2. The fluid ejection head of claim 1, wherein pulsing the at least the first actuator device with the first energy and pulsing the at least the second actuator device with the second energy results in the viscosity of the first fluid to be same as the viscosity of second fluid.

3. The fluid ejection head of claim 1, wherein the at least the first actuator device is formed on a first substrate and the at least the second actuator device is formed on a second substrate, the first substrate and the second substrate being thermally isolated from each other.

4. The fluid ejection head of claim 1, wherein the first fluid is a monochrome ink and the second fluid is a color ink.

5. The fluid ejection head of claim 1, wherein the first fluid and the second fluid are inks having different colors.

6. The fluid ejection head of claim 1, wherein the plurality of actuator devices are heater resistor devices.

7. A method for purging bubbles from a plurality of fluid flow channels, a plurality of fluid ejection nozzles, and a plurality of ink vias of a fluid ejection head, the fluid ejection head comprising the plurality of fluid flow channels including a first plurality of fluid flow channels for flow of a first ink and a second plurality of fluid flow channels for flow of a second ink, the first ink being different from the second ink, a plurality of actuator devices including at least a first actuator device in thermal communication with the first plurality of fluid flow channels for heating the first ink, and at least a second actuator device in thermal communication with the second plurality of fluid flow channels for heating the second ink, the plurality of ink vias formed within the plurality of actuator devices, the plurality of ink vias in fluid communication with the plurality of fluid flow channels, a nozzle plate attached to the plurality of actuator devices, the nozzle plate containing the plurality of fluid ejection nozzles corresponding to the plurality of ink vias, and a printer cap positioned adjacent the nozzle plate, the method comprising:
pulsing the at least the first actuator device with a first energy;
pulsing the at least the second actuator device with a second energy; and
applying a negative pressure through the printer cap to purge bubbles from the first plurality of fluid flow channels, the second plurality of fluid flow channels, the plurality of ink vias, and the plurality of fluid ejection nozzles, the first energy being different from the second energy, the first energy and the second energy depending on the viscosity of the first ink and the second ink.

8. The method of claim 7, wherein pulsing the at least the first actuator device with the first energy and pulsing the at least the second actuator device with the second energy results in the viscosity of the first ink to be same as the viscosity of second ink.

9. A method for purging bubble clogged in a fluid ejection nozzle of a fluid ejection head, the fluid ejection head comprising a plurality of fluid flow channels including a first plurality of fluid channels for flowing a first ink and a second plurality of fluid flow channels for flowing a second ink, a nozzle plate including a plurality of fluid ejection nozzles, the fluid ejection nozzles including a first plurality of fluid ejection nozzles in fluid communication with the first plurality of fluid flow channels and a second plurality of fluid ejection nozzles in fluid communication with the second plurality of fluid flow channels, a plurality of actuator devices including a first actuator device associated with the first plurality of fluid ejection nozzles and a second actuator device associated with the second plurality of fluid ejection nozzles, and a printer cap positioned adjacent the nozzle plate, the method comprising:
printing a pattern comprising a plurality of dots, each of the plurality of dots represents fluid ejection from the plurality of fluid ejection nozzles;
scanning the pattern to determine missing one of the plurality of dots in the pattern, the missing one of the plurality of dots being indicative of a clog in one of the plurality of the fluid ejection nozzles;
pulsing the actuator device associated with the clogged fluid ejection nozzle; and
applying a negative pressure through the printer cap to purge the bubble from the clogged fluid ejection nozzle.
